(19) United States
(12) Patent Application Publication
(10) Pub. No.: US 2010/0151402 A1
(43) Pub. Date: Jun. 17, 2010

(54) Slide on connector for arch wire

(76) Inventor: Michael O. Williams, Gulfport, MO (US)

Correspondence Address: Paul M. Denk, 763v S. New Ballas Rd., St. Louis, MO, 63141, US

(21) Appl. No.: 12/316,507

(22) Filed: Dec. 12, 2008

(51) Int. Cl. A61C 7/12

(52) U.S. Cl. 433/7

(57) ABSTRACT

A slide on connector for positioning upon an arch wire between the teeth of an orthodontic patent is provided. This connector works in conjunction with maxillary and mandibular arch expanders and other orthodontic appliances. The connector includes a base casing with a body segment and a base segment where both include a threaded bore. A screw is then threadedly engaged through the body and into the base segment. The base segment has tubes attached thereto for the insertion of an arch wire and the screw turns upon the arch wire for securement. The tubes can be preangulated to assist in root angulation or other orthodontia when the arch wire is inserted.

### CROSS REFERENCE TO RELATED APPLICATION

This non-provisional application claims priority to the pending non-provisional application for patent Ser. No. 12/006,505 filed Jan. 3, 2008 which claims priority to the provisional application Ser. No. 60/881,330 filed on Jan. 19, 2007, and this application claims priority to the pending non-provisional application Ser. No. 11/480,681, filed Jul. 1, 2006 which claims priority to the non-provisional application for patent Ser. No. 10/439,638, filed May, 16, 2003, now U.S. Pat. No. 7,094,051, which is commonly owned by the same inventor, and which is a continuation-in-part of application Ser. No. 10/186,604, filed Jul. 2, 2002, now U.S. Pat. No. 6,877,982, which is a continuation-in-part of application Ser. No. 09/975,633, filed Oct. 12, 2001, now U.S. Pat. No. 6,719,557, and which is a continuation-in-part of application Ser. No. 09/750,527, filed Dec. 29, 2000, now U.S. Pat. No. 6,520,772, which is a continuation-in-part of application Ser. No. 09/598,766, filed Jun. 22, 2000, now U.S. Pat. No. 6,402,510, which is a continuation-in-part of application Ser. No. 09/406,426, filed Sep. 27, 1999, now U.S. Pat. No. 6,241,517, which is a continuation-in-part of application Ser. No. 09/143,071, filed Aug. 28, 1998, now U.S. Pat. No. 6,036,488, which, in turn, is a continuation-in-part of application Ser. No. 09/065,344, filed Apr. 23, 1998, now U.S. Pat. No. 5,919,042, which is related to application Ser. No. 08/526,686, filed Sep. 11, 1996, now U.S. Pat. No. 5,645,422, and related to Ser. No. 08/688,110, filed Jul. 29, 1996, now U.S. Pat. No. 5,769,631, all of which are incorporated herein by reference.

### BACKGROUND OF THE INVENTION

This invention relates generally to orthodontic appliances for lengthening the upper, or maxillary, and the lower, or mandible, jaws of a person. And more specifically the invention pertains to a connector that slides upon an arch wire and then secures to the arch wire at a selected position without using bands or crowns upon teeth. The connector then cooperates with other devices for adjusting the positions of teeth and the shapes of the maxillary and mandibular jaws while improving the appearance of a person's mouth and teeth through usage of the present invention.

Orthodontists have labored towards correcting tooth positions and related jaw conditions to remedy various conditions afflicting patients. Such conditions include overbite and underbite, improper chewing, dental speech impediments, hygiene, and appearance. As a further complication to patients, the lower jaw, or mandible, may grow during a person's lifetime and affect the alignment of teeth in both jaws. To begin, each tooth can be rotated and translated into a new location or orientation as it secures to the jaw with a periodontal ligament. Though extremely strong, the periodontal ligament stretches like other ligaments as a tooth moves. Generally, a tooth is moved in increments from an initial to a final position, often along a standard arc like shape.

Orthodontists use many devices and therapies to move teeth while remedying conditions. Common braces have a wire secured to brackets or bands upon teeth. The brackets were once adhered to the exterior face of a tooth but presently the demands of patients call for securing the brackets to the interior face of a tooth. A wire then is placed upon the bracket and secured by small diameter elastic bands. The arcuate shape of the wire corresponds to the desired position of teeth. Wires have sizes that increase incrementally in diameter and hence rigidity so changing wires from smaller to larger diameters over time generally moves the teeth into a desired position. Each tooth attains its desired position according to the orthodontic treatment plan through the rigidity of the wire. Brackets generally are used in positions rearward from the incisors.

### DESCRIPTION OF THE PRIOR ART

For following an orthodontic plan, an orthodontist may have to create additional space along the jaw to ease tooth movement. Moving teeth rearward opens the space for guiding teeth towards their final positions. An orthodontist applies bands to the molars and if needed, teeth towards the front of the mouth. A band generally adheres to and surrounds a tooth. A fitting generally upon the exterior of a band secures the end of a wire used to establish a desired arc for the teeth on a jaw. Bands also have sockets, generally horizontal, upon the exterior that cooperate with headgear having interior rods received into the sockets upon the molars and an integral outer bow. The outer bow connects to an adjustable strap around the patient's neck. The strap provides a rearward force into the bow and the interior rods to move the molars rearward. This action opens additional space for other teeth that then move to desired positions upon the jaw.

Orthodontists treating children often need to gain space in a child's mouth for unerupted mandibular incisors and to increase intercanine distance for narrow arch forms, as well as to distillize mandibular first molars so that a total increase of arch length is available in the lower dental arch from first molar to first molar. Furthermore, the orthodontist may want to expand the palate correspondingly.

Mandibular and maxillary arch expanders are known in the art to expand and lengthen the mandibular and maxillary arch lengths. The use of such arch expanders helps avoid the need for tooth extraction of permanent teeth due to overcrowding. However, such mandibular arch expanders are rather bulky in design, uncomfortable to wear, impede tongue mobility, and interfere with oral hygiene. The devices must be substantial in design to resist torque or leverage mechanics during chewing.

To facilitate enlargement of the maxillary and mandibular arches, telescoping mechanisms have been employed which encourage forward repositioning of the lower jaw as the patient's mouth closes into occlusion. Such devices are commonly referred to as Herbst appliances. Current Herbst appliances include a hollow tube and a rod which is telescopically received in the tube. The tube is connected to the maxillary arch expander and the rod is connected to the mandibular arch expander. Generally, the tube and rod are connected to a band or stainless steel crown by a pivoting connection.

The orthodontic bands are interconnected by a pair of adjustable connector assemblies. The connector assemblies include an expandable tube assembly and a rod which extends through the expandable tube assembly such that the tube and the rod are telescopically movable relative to each other. The expandable tube assembly has an eye at a first end thereof for the insertion of the pivotal mounting boss screw to pivotally secure the connector to the rear orthodontic band of the maxillary arch. The rod has an eye adjacent a second end of the expandable tube assembly for the insertion of the pivotal mounting boss screw to be connected to base casing attached to the front orthodontic bands of the mandibular arch expander.

The pivot generally comprises a base casing which is soldered or welded to the band or crown and a screw that is inserted through an eye formed on the end of the hollow tube or rod. The screw threadedly engages the base casing and is tightened, leaving enough clearance for the eye to pivot about the screw. Often the orthodontist uses an arch wire connected between the two ends of the arch expander. In the past, to accommodate the arch wire, the orthodontist or technician first must attach a rectangular wire tube to the band or crown and then attach the base case on top of the rectangular tube. This arrangement has a relatively high profile caused by the stacking of the rectangular tube and base casing along with the increased solder mass.

### SUMMARY OF THE INVENTION

The present invention provides an improved pivotal mounting boss for attachment upon an arch wire as a component of an orthodontic treatment plan which may include front or rear orthodontic bands on a mandibular arch expander and a maxillary arch expander. The pivotal mounting boss includes a base casing with an opening formed therein that admits an arch wire. A screw is then threadedly engaged through the base casing. The screw passes through the base casing and contacts the arch wire for compression against the remainder of the base casing. Further, the opening can be pre-angulated to assist in root angulation when the arch wire is inserted.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is, therefore, the principal object of this invention to provide a slide on connector for an arch wire that moves along an arch wire for selected positioning and securement upon the arch wire without permanently attaching to a patient's teeth.

Another object of the invention provides for a slide on connector for an arch wire that can accommodate an arch wire for a mandibular expander, maxillary expander, and like orthodontic devices.

Yet another object of the invention provides for a slide on connector for an arch wire that reduces the profile of the arch wire and related attachments outwardly of a patient's teeth.

Another object is to provide such a slide on connector for an arch wire that has an integral arch wire tube.

Still another object of the invention is to provide a slide on connector for an arch wire that allows for low profile soldering or welding.

Yet another object of the invention is to provide a slide on connector for an arch wire that accommodates an arch wire for a mandibular expander thus improving patient comfort.

Another object of the invention is to provide a slide on connector for an arch wire that can accommodate a mandibular expander having a pre-torqued and pre-angulated opening in the base casing that assists in root angulation when the arch wire is inserted.

Another object of the invention is to provide a slide on connector for an arch wire that is readily manufactured, efficient to install, and well suited for its intended purposes.

And, another object of the invention is to provide a slide on connector for an arch wire that can be moved or adjusted by loosening or removing the screw head.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings,

FIG. 1 is a perspective view of a mandibular arch expander and maxillary arch expander which are shown mounted in a mold and connected by a telescoping assembly of the embodiment;

FIG. 1A is a bottom plan view of the maxillary arch expander mounted in the mold with the telescoping assembly mounted thereto;

FIG. 1B is a top plan view of the mandibular arch expander mounted in the mold with the telescoping assembly mounted thereto;

FIG. 1C is a top plan view similar to that of FIG. 1B, but with an alternative mandibular arch expander;

FIG. 1D is a top plan view of a mandibular molar space closer which can be used with the telescoping assembly of the embodiment;

FIG. 2 is a side elevational view of the telescoping assembly, partially in cross-section;

FIG. 3 is a front plan view of the telescoping assembly;

FIG. 4 is a side elevational view of a rod of the telescoping assembly;

FIG. 5 is a front elevational view of the rod;

FIG. 6 is a side elevational view of a posterior tube of the telescoping assembly;

FIG. 7 is a rear elevational view of the posterior tube;

FIG. 8 is a side elevational view of an anterior tube of the telescoping assembly;

FIG. 9 is a front end elevational view of the anterior tube;

FIG. 10 is a back end elevational view of the anterior tube;

FIG. 11 is an exploded view of a prior art pivotal mounting boss assembly and an orthodontic band with a rectangular tube interposed to accommodate an arch wire;

FIG. 12 is a perspective view of the prior art pivotal mounting boss assembly of FIG. 11 attached to an orthodontic band with a rectangular tube interposed to accommodate an arch wire;

FIG. 13 is a perspective view of the improved pivotal mounting boss assembly of the embodiment attached to an orthodontic band;

FIG. 14 is a front elevational view of the improved pivotal mounting boss assembly of the embodiment attached to an orthodontic band;

FIG. 15 shows a side view of the components of an embodiment for advancing the lower jaw of a patient without moving teeth;

FIG. 16 shows an exploded view of the embodiment with the heads having recesses for a flush mount of the mechanical fasteners;

FIG. 17 describes an alternate embodiment of the lower member having a slight angle outward from the installation upon the lower jaw;

FIG. 18 illustrates the embodiment installed upon the upper and lower jaws of a patient upon the left side of the jaw to remedy an overbite;

FIG. 19 presents the embodiment installed upon the left side of both the upper and lower jaws to remedy an underbite;

FIG. 20 provides an embodiment similar to FIG. 14 but mounted upon two teeth with a biasing member between them secured by screws into bands;

FIG. 21 provides an embodiment similar to FIG. 18 but mounted upon two teeth with an expanding member between the teeth, also secured by screws into bands;

FIG. 22A illustrates a top view of the present invention with the mount and a cooperating screw and FIG. 22B shows a side view of the mount;

FIG. 23 describes an isometric view of the mount installed upon an arch wire;

FIG. 24 shows an exploded view of the screw connecting through the mount of the present invention and

FIG. 25 is a side view of the invention with the screw secured fully into the mount; and,

FIG. 26 illustrates two of the present invention securing to an arch wire in a typical orthodontic installation with a biasing member.

The same reference numerals refer to the same parts throughout the various figures.

### DESCRIPTION OF THE PREFERRED EMBODIMENT

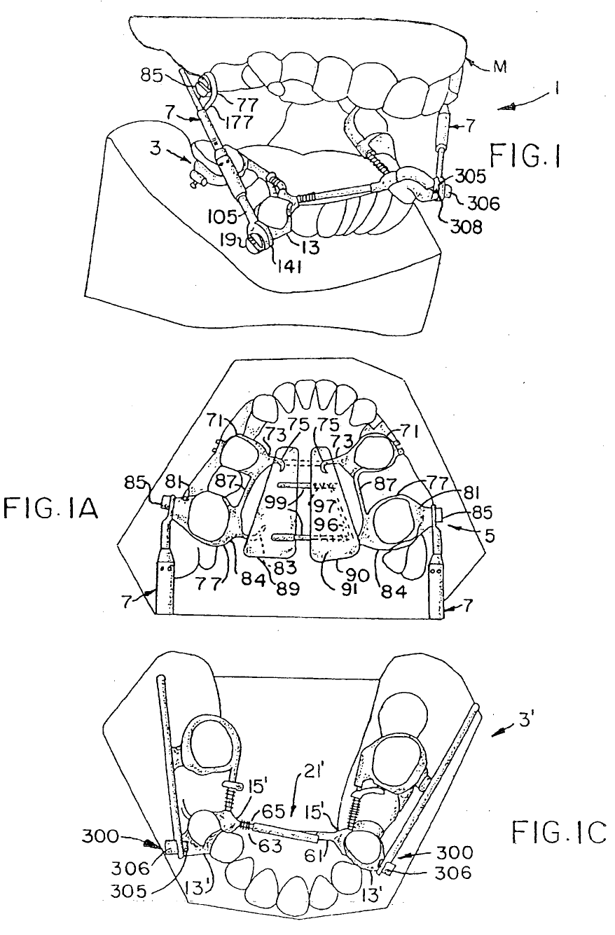

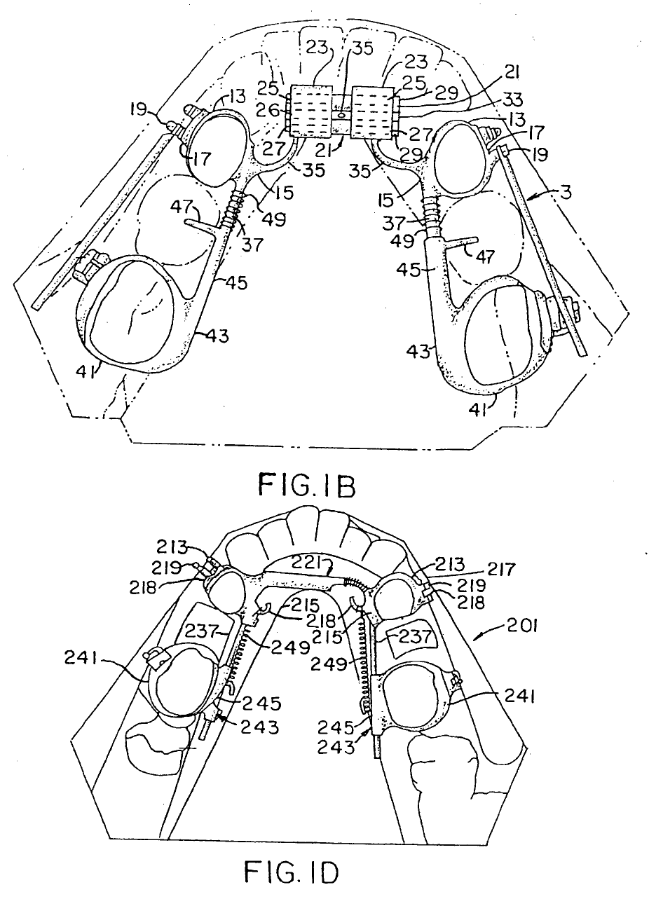

In referring to the drawings, FIGS. 1-1B, an orthodontic appliance 1 of the present invention is shown mounted in a mold M of a mouth. Although the appliance 1 is shown mounted in a mold, it will be appreciated that it is designed for use in a human mouth to increase the size of a child's mouth so that the child's permanent teeth will not be crowded when they erupt. This will reduce the need for extractions of permanent teeth. The appliance 1 includes a mandibular arch expander 3, a maxillary arch expander 5, and a pair of telescoping assemblies 7 which extend between and connect the mandibular and maxillary arch expanders 3 and 5, as described below.

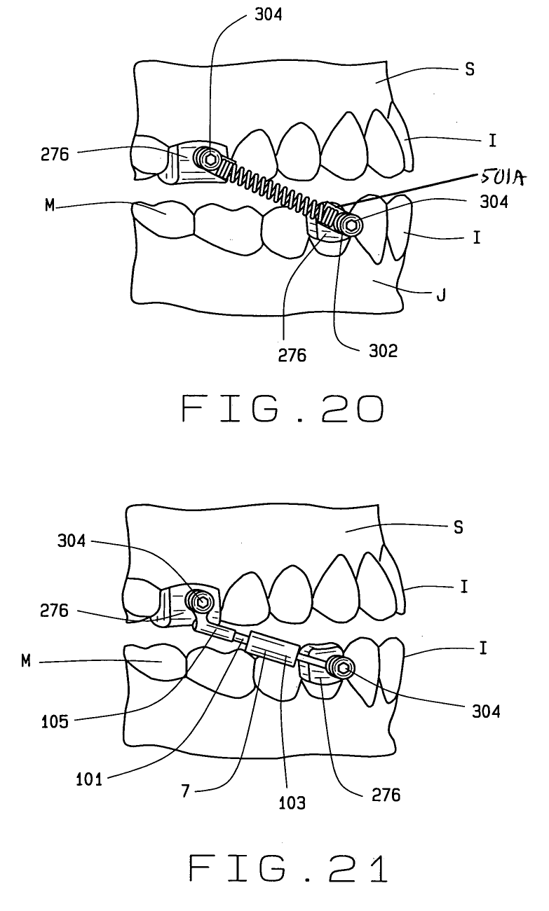

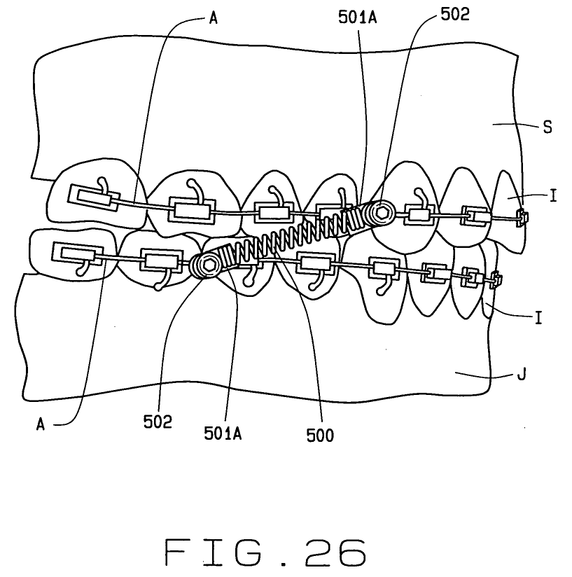

The mandibular and maxillary arch expanders 3 and 5 are substantially the same as the arch expanders set forth in my above noted U.S. Pat. No. 5,645,422, which is incorporated herein by reference. The mandibular arch expander 3 (FIG. 1B) has a pair of spaced apart forward orthodontic bands 13 which are adapted to attach to the mandibular first primary molars. Bands 13 each have a boss 15 positioned on the lingual side of the bands and a boss 17 positioned on the buccal side of the bands. The buccal bosses 17 are adapted to receive screws 19 to connect the telescoping assemblies 7 to the mandibular arch expander 3, as will be discussed below. The respective bosses 15 and 17 are integrally formed on the respective bands to provide a substantial metallic body for the attachment of other elements to be described hereinafter. The improved pivotal mounting boss which can accommodate an arch wire, which is the subject matter of this invention, will be described in FIGS. 20-26.

The bands 13 are interconnected by an expansion complex 21. The expansion complex 21 has a pair of metal blocks 23. The blocks 23 each have three bores 25, 26, and 27 formed laterally therethrough. The bores 25, 26, and 27 of the two blocks 23 are in substantial horizontal alignment. Aligning pins 29 extend through the outer bores 25 and 27. The respective aligning pins 29 are slightly undersized relative to the respective bores 25 and 27 so that the blocks 23 will slide relative to the pins 29. The middle bores 26 are threaded and receive a threaded screw 33. There is at least one hole 35 formed through the middle of screw 33 between the oppositely threaded ends. The hole 35 accommodates the insertion of a small tool to turn screw 33. It will be appreciated that threaded screw 33 has oppositely threaded ends. Therefore, when screw 33 is rotated in one direction, the blocks 23 are moved away from each other and when screw 33 is rotated in the opposite direction, the blocks 23 are drawn toward each other. The blocks 23 slide on the aligning pins 29 and the aligning pins serve to stabilize the expansion screw complex.

The blocks 23 are mounted to the lingual bosses 15 by curved arms 35 which extend between the bosses 15 and the block 23. The curved arms 35 can be of any appropriate length and curvature to suitably engage the patient's teeth. The mold M is made following conventional procedures and the arms 35 are fabricated to be the appropriate length and curvature. The arms 35 then are soldered to the appropriate boss 15 and to the expansion screw complex 21.

A rod 37 extends rearwardly from each of the lingual bosses 15. The rod 37 can be a small hollow tube, to reduce weight, or can be a solid rod. A stated above, the exact position on the respective bosses 15 where the rods 37 are attached and the angle at which the rod 37 extends from the bosses 15 depends upon the patient and the patient's needs. It will be appreciated that arms 35 and rods 37 can be one integral piece appropriately bent to form the arm and the rod or the arm and rod can be separate pieces.

The mandibular arch expander 3 also has a pair of spaced apart rear orthodontic bands 41. The bands 41 generally are molar bands and, in use, are attached to the permanent first molars. Each band 41 has an integral boss 43 positioned on the lingual side of the bands. A hollow tube 45 extends forwardly from each boss 43. The hollow tubes 45 have an internal bore sized to accommodate the sliding insertion of the rods 37, as will be explained in detail below.

A pair of short wires 47 extend perpendicularly from the tubes 45. The respective short wires 45 extend buccally and serve as occlusal rests and are soldered on the respective tubes at a position corresponding to the lingual occlusal groove of the deciduous second molars bilaterally to provide extra support and stability to the tubes.

The forward pair of orthodontic bands 13 is connected to the rear pair of orthodontic bands 41 to promote molar distalization and added arch length development by a pair of spring-loaded rod and tube assemblies. Rods 37 are slidingly engaged in tubes 45. Coil springs 49 are positioned around rod 37 and fixed between bosses 15 and the end of the tube 45. The coil springs 49 are sized so they abut the ends of the tubes 45 and do not slide over the tubes 45. The respective coil springs 49, therefore, urge the forward bands 13 away from the rear bands 41 to increase palate length.

The coil springs 49 have a preset tension. The preset tension of the spring is selected by the orthodontist to effect the appropriate mesial distal arch length development in the bicuspid area.

An alternative embodiment of the mandibular arch expander 3′ of the present invention is shown in FIG. 1C. The mandibular arch expander 3′ is substantially identical to the mandibular arch expander 3 shown in FIG. 1B. It varies, however, in the construction of the expansion complex 21′. The arch expander 3′ includes spaced apart forward orthodontic bands 13′ having lingual bosses 15′. The expansion complex 21′ includes a hollow tube 61 extending from one boss 15′ and a rod 63 extending from the other boss 15′. The angles at which the tube 61 and rod 63 extend from the respective bosses depends upon the shape of the patient's mouth. The rod 63 is slidingly engaged in the tube 61. A coil spring 65 is journaled around the rod 63 and fixed between the boss 15′ and the end of the tube 61. The spring 65 is sized to engage the end of the tube 61 and not slip over the tube 61. Therefore, the spring 65 urges the forward bands 13′ away from each other. The spring 65 has a predetermined force to be delivered between the molars to widen the anterior canine width.

The maxillary palatal expander 5 (FIG. 1A) has a pair of spaced apart forward orthodontic bands 71 which are adapted to attach to the maxillary molars. The each band 71 has a boss 73 positioned on the lingual side of the bands. The respective bosses are integrally formed on the respective bands. There is an integral curved member or hook 75 extending inwardly or lingually from the bosses 73.

A pair of spaced apart rear orthodontic bands 77 are positioned rearwardly of the forward bands 71. The bands 77 each have an integral lingual boss 84 and an integral buccal boss 81. The lingual bosses 84 have an integral curved member or hook 83. The buccal bosses 81 each have a screw hole to revive a screw 85 to connect the telescoping tube assemblies 7 to the maxillary arch expander 5.

The forward orthodontic bands 71 are connected to the rear orthodontic bands 77 by a rod 87. Furthermore, the hooks 75 and 83 are embedded in plastic plates 89 and 90. The respective plastic plates are molded to fit the patient's palate. Each plate, with the associated forward and rearward bands, comprises half of the expander 5. The halves of the expander 5 are biased away from each other to widen the maxillary arch. There is a substantially U-shaped rod 91 imbedded in plate 90. The rod 91 has legs which extend out from, and at substantially right angles to, the plastic plate 90. Coil springs 96 and 97 are journaled around legs, respectively. A pair of short tubes 99 are embedded in the plate 89. The tubes 99 extend out of the palate plate 89 at substantially right angles to the palate plate. The tubes 99 are on complementary alignment with the legs of the U-shaped rod 91 and are slightly oversized so that the legs can slide into the tubes. The springs 96 and 97 abut the ends of the tubes 99 and exert tension force to urge the halves of the appliance apart. The appropriate tension can be exerted by selecting springs with the appropriate tension.

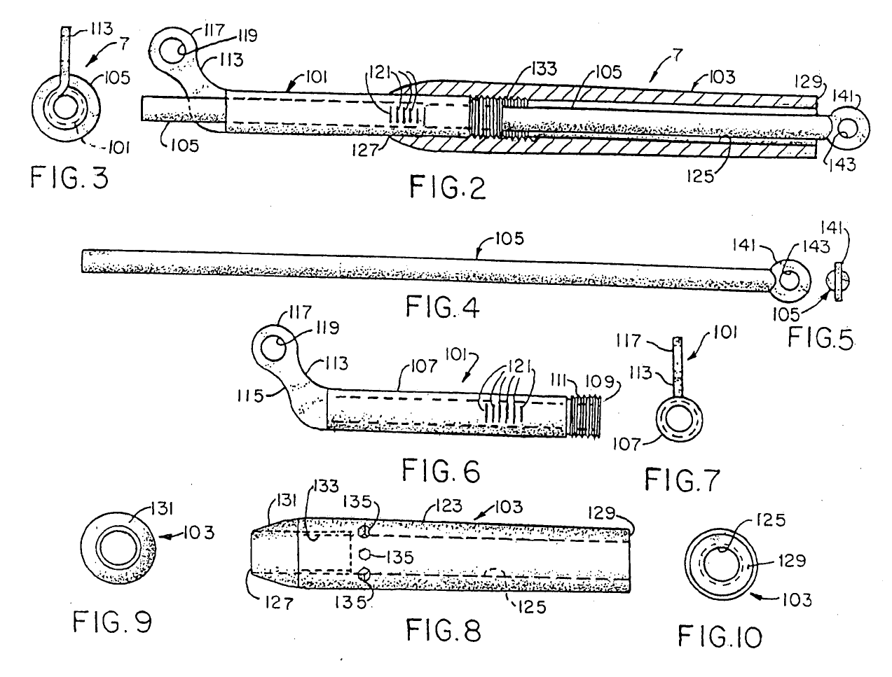

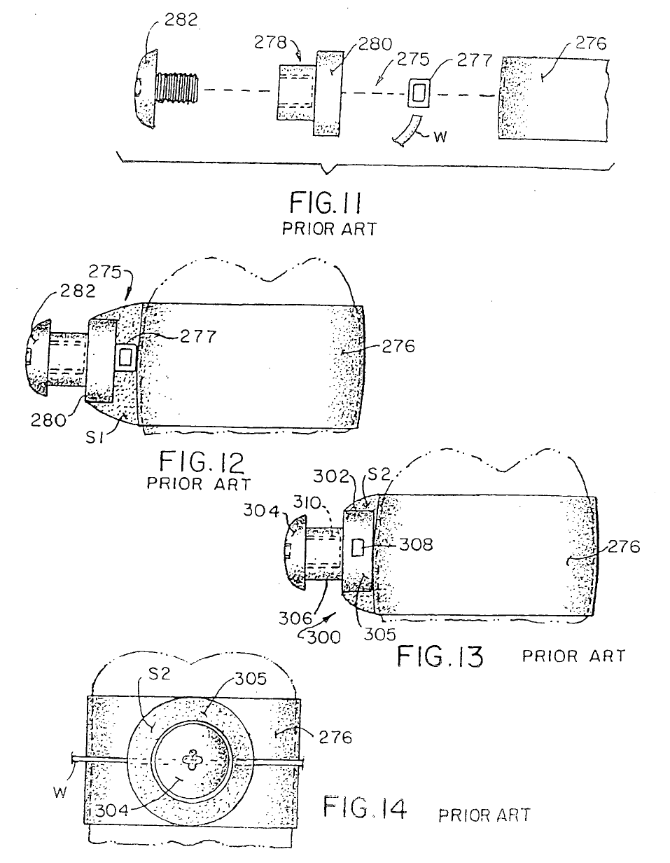

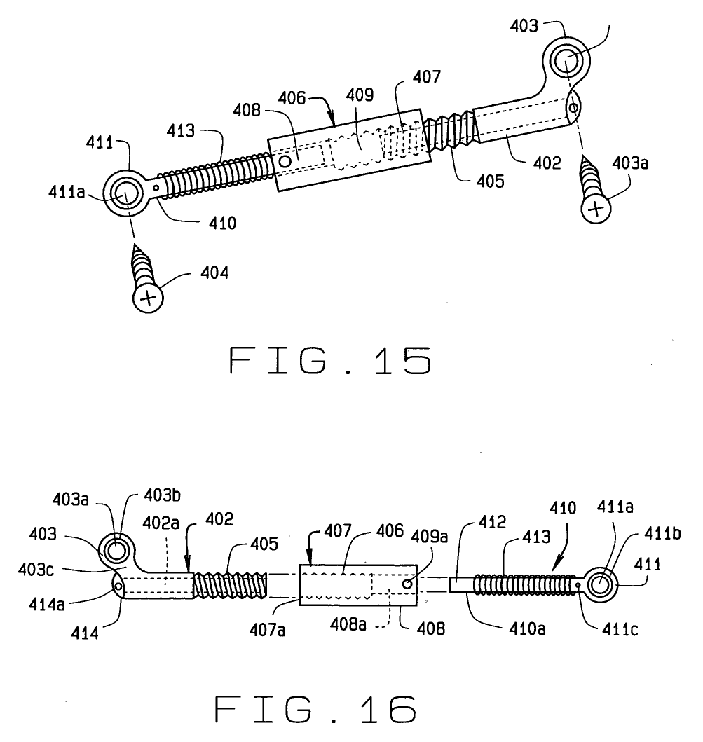

To facilitate transverse development of the lower jaw relative to the upper jaw, the maxillary and mandibular arch expanders are interconnected by the telescoping Herbst type assemblies 7, which are shown in detail in FIGS. 2-10. The two assemblies are identical and include a posterior tube 101, an anterior tube 103, and a rod 105 which extends through the two tubes 101 and 103. The posterior tube 101 includes a hollow body 107 which is open at both its front and back ends. The body 107 has an outer diameter which is substantially constant between its front and back ends. The back end 109 is externally threaded, as at 111. An arm 113 extends upwardly from the tube's body 107 at the front 115 of the body. The arm 113 has an eyelet 117 at its free end, the eyelet having a hole 119 therein. Intermediate its front and back ends, the posterior tube 101 includes a plurality of tick marks 121 which are used to indicate the amount of advancement of the anterior tube 103 over the posterior tube 101, as will be described below. The tick marks 121 are preferably separated by about one-millimeter.

The anterior tube 103 includes a hollow body 123 defining a bore 125 therethrough. The tube 103 is open at both its back and front ends 127 and 129, respectively. The front end 127 of the tube tapers inwardly, as at 131 such that the very front of the tube 103 has a smaller outer diameter than the rest of the tube's body 123. As seen in FIGS. 8 and 10, the body 123 also tapers slightly from the back of the surface 131 to the back 129 of the body 123. The tube 123 is internally threaded at its front end, as at 133. The diameter of the bore 125 is slightly greater than the outer diameter of the anterior tube 101, and the threads 111 and 133 of the tubes 101 and 103, respectively, are machined or otherwise formed so that they will mate. Thus, the anterior and posterior tubes 101 and 103 are threadedly connected together. Notches or holes 135 are formed on the exterior of the posterior tube body 123. The notches 135 are adapted to receive a tool having a correspondingly shaped head. The tool can be used to rotate the posterior tube 103 relative to the anterior tube 101 when the appliance 1 is mounted in a patient's mouth.

The rod 105 is a generally straight rod. It has a generally constant diameter slightly less than the inner diameter of the anterior tube 101, so that it may slide relative to the tube 101. At its back end, the rod 105 has an eyelet 141 having a hole 143.

A mandibular molar space closer 201 is shown in FIG. 1D. As can be seen, it is similar to the mandibular arch expander of FIG. 1C. The molar space closer 201 has a pair of spaced apart forward orthodontic bands 213 which are adapted to attach to the mandibular first primary molars. The bands 213 each have a boss 215 positioned on the lingual side of the bands and a boss 217 positioned on the buccal side of the bands. The buccal bosses 217 are adapted to receive screws 219 to connect the telescoping assemblies 7 to the mandibular arch expander 3. The respective bosses 215 and 217 are integrally formed on the respective bands to provide a substantial metallic body for the attachment of other elements to be described hereinafter. A hook 218 extends from the lingual boss 215 and points forwardly, toward the front of the patient's mouth.

The bands 213 are interconnected by an expansion complex 221. The expansion complex 221 is identical to the expansion complex 21′ of the mandibular arch expander 3′.

A rod 237 extends rearwardly from each of the lingual bosses 215. The rod 237 can be a small hollow tube, to reduce weight, or can be a solid rod. A stated above, the exact position on the respective bosses 215 where the rods 237 are attached and the angle at which the rod 237 extends from the bosses 215 depends upon the patient and the patient's needs.

The mandibular molar space closer 201 also has a pair of spaced apart rear orthodontic bands 241. The bands 241 generally are molar bands and, in use, are attached to the permanent first molars. Each band 241 has an integral boss 243 positioned on the lingual side of the bands. A hollow tube 245 extends along the lingual side of the band and through the boss 243. The hollow tubes 245 have an internal bore sized to accommodate the sliding insertion of the rods 237. The rods 237 are sized such that they will pass through the tubes 245 to extend beyond the rear of the tubes 245.

The forward pair of orthodontic bands 213 are connected to the rear pair of orthodontic bands 241 to reduce the spacing between molars using a pair of spring-loaded rod and tube assemblies. Rods 237 are slidingly engaged in tubes 245, as noted. Coil springs 249 are connected to the rod 237 behind the rear molar band 241 and to the hooks 218. As seen, in this position, the springs 249 are in an expanded state. The respective coil springs 249, therefore, pull the bands 213 and 241 towards each other to decrease the spacing between molars. The coil springs 249 have a preset tension. The preset tension of the spring is selected by the orthodontist to effect the appropriate mesial distal arch length development in the bicuspid area.

The telescoping tube assemblies 7 are assembled by threadedly connecting the anterior and posterior tubes 101 and 103, and sliding the rod 105 into the tube assembly. The rod 105 is slid into the tube assembly such that its eyelet 141 will be at the opposite end of the assembly from the anterior tube eyelet 117.

As best seen in FIG. 1, the tube assemblies 7 extend between the forward bands 13 on the mandibular arch expander 3 and the rear bands 77 on the maxillary arch expander 5. The screws 85 of the maxillary arch expander pass through the eyelet's 117 of the anterior tubes 101 to pivotally connect the tube assembly to the maxillary arch expander. Similarly, the screws 19 of the mandibular arch expander 3 pass through the eyelets 141 of the rod 105 to connect the assembly 7 to the mandibular arch expander 3.

When initially inserted in a patient's mouth, the telescoping tube assemblies 7 are sized such that the back end 129 of the posterior tube 103 is in contact with the eyelet 141 of the rod 105 when the patient's mouth is shut. This will apply a forwardly directed pressure on the mandible. Thus, with all three components (i.e., the mandibular and maxillary arch expanders 3 and 5, and the telescoping tube assemblies 7 and 8) installed in a patient's mount, the appliance 1 will allow for transverse development, arch length development, palatal expansion and mandibular advancement, simultaneously without requiring patient compliance.

By rotating the tube 103 in one direction, the tube 103 will advance over the tube 101, to shorten the overall length of the tube assembly 7. Conversely, by rotating the tube 103 in a second direction, the tube 103 will be retracted relative to the anterior tube, to increase the overall length of the tube assembly. The extent of the movement of the tubes 101 and 103 relative to each other is measured by the tick marks 121. The interior threads 33 of the tube 103 and the tick marks 121 of the tube 101 are positioned on their respective tubes, such that when the tube 101 is threaded into the tube 103, the tick marks 121 will be exposed. By rotating the two tubes relative to each other, the number of tick marks exposed increases or decreases, depending on the direction of rotation, to indicate how far the tube assembly has been lengthened or shortened by the rotation of the tubes relative to each other. Thus, by reading the number of tick marks exposed, the practitioner can determine the amount of advancement that has occurred, as well as the overall length of the assembly 7.

A prior art mounting boss assembly accommodates an arch wire W as shown in FIGS. 11 and 12 and indicated generally by reference numeral 275 shown in use with an orthodontic band 276. It will be appreciated that assembly 275 is described as attached to an orthodontic band but can be attached to a stainless steel crown as well Assembly 275 functions as the above described bosses attached to the orthodontic bands. However, assembly 275 is modified to allow the attachment of arch wires. The prior art assembly 275 includes a short segment of square tubing 277 which is attached to the band 276 by soldering S1, for example. The square tubing is position on the orthodontic band for the attachment of an arch wire W, if needed. A mounting boss 278 including a base casing 280 and a screw 282 is then soldered on top of the square tubing. It will be appreciated by those skilled in the art that the prior art assembly 275 requires a substantial solder joint S1 to secure the elements which results in a high profile boss. Moreover, installation of the boss on the band requires addition time and costs.

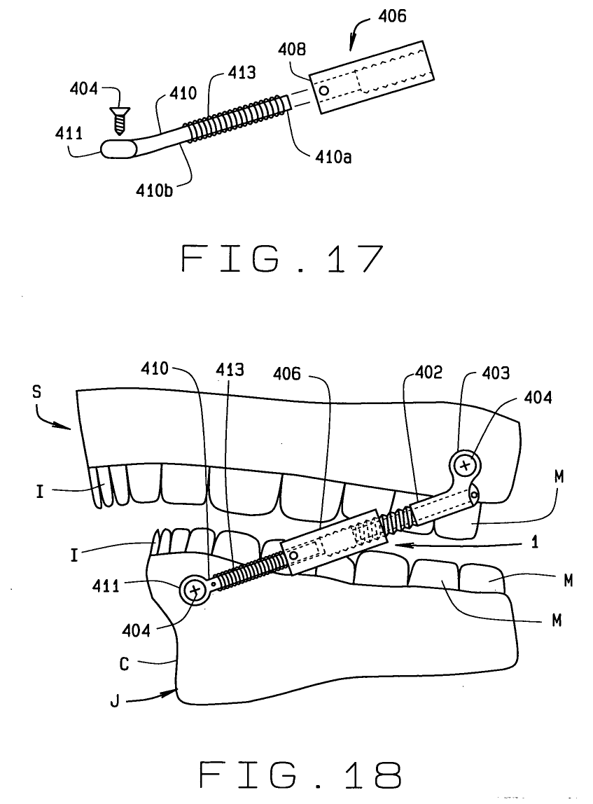

An improved pivotal mounting boss is illustrated in FIG. 13 and shown in application in FIGS. 1, 1C and 2 is indicated generally by reference numeral 300. Mounting boss 300 includes a base casing 302 and a threaded screw 304. Base casing 302 includes a generally cylindrical base segment 305 and a concentric cylindrical body segment 306. Base segment 305 has an opening 308 formed therein. In the illustrated embodiment opening 308 is rectangular and is designed to accommodate a conventional arch wire W. See FIG. 14. The base segment can be position on the orthodontic band 276 and soldered in place with solder S2. It will be appreciated that the opening 308 can be positioned at a predetermined angle as desired by the orthodontist for root angulation. It will be appreciated that less solder S2 is required to attach boss 300 to the orthodontic band resulting in less bulk and a lower profile arrangement than that shown in FIG. 12.

The body segment 306 includes an internally threaded bore 310 for the threaded engagement of screw 304. The screw 304 is inserted through the eyelet of the orthodontic device described above and tightened, leaving enough clearance so that the eyelet can rotate or pivot about the screw.

Then FIG. 15 shows one jaw advancer 401 of the two required to treat a jaw symmetrically. The jaw advancer has an upper member 402 having an elongated cylindrical shape in the form of an L, when seen from the side. The upper member is generally hollow. The upper member has a head 403 offset and perpendicular to the length of the upper member. The head is generally rounded and has a hole 403a to admit a mechanical fastener, here shown as a screw 404. Opposite the head, the upper member has a threaded end 405.

The advancer then has a socket 406, generally cylindrical in shape and also hollow, with two opposed ends. The socket has a threaded end 407 that cooperatively engages the threaded end of the upper member. Opposite the threaded end, the socket has a smooth bore 408. Upon the surface of the socket, marks 409 assist an orthodontist, or in some cases a patient, in turning the socket which effectively lengthens the advancer to move the jaw forward.

Opposite the upper member and the socket, the advancer has a lower member 410. The lower member has a generally cylindrical shape with a head upon one end and an opposite smooth end. This head 411 is generally rounded and coaxial with the longitudinal axis of the lower member. Opposite the head, the smooth end 412 has a generally round cross section that fits into the smooth bore of the socket. Upon the lower member, located between the head and the socket, a spring 413 is coaxial with the longitudinal axis of the lower member and provides an expansive force from the socket to the head 411 of the lower member 410. This expansive force urges the lower jaw forward and in time the musculature responds and adjusts it position and strength to accommodate a more forward jaw. The head of the lower member admits a mechanical fastener, or screw as at 404, through a hole 411a for securement into the lower jaw.

FIG. 16 shows the components of the advancer in an exploded view. The upper member 402 has a head 403 outward, offset, and perpendicular from the main portion of the upper member. The head defines the outward portion of the somewhat L shape of the upper member. The head has a generally ring ling shape, rounded for the comfort of the patient. Centered upon the head, a hole 403a admits a mechanical fastener 404 as previously described. The head has a recess around the perimeter of the hole to seat the mechanical fastener flush to the head. The head itself joins to the upper member upon a neck 403c of lesser width than the diameter of the head. The neck is generally solid in cross section due to the forces imparted by the remainder of the upper member. Here shown, the upper member is generally a hollow cylindrical form, as at 402a, with a threaded end opposite the head. The threaded end 405 extends at least partially along the length of the upper member. The threaded end has an outer diameter similar to the diameter of the upper member without threads. Except for the threaded end, the remainder of the upper member is generally rounded and smoothed for the comfort of the patient. In an alternate embodiment, adjacent to the neck and opposite the threaded end, the upper member has a perpendicular tab 414 extending away from the upper member. The tab also has a small hole 414a for attachment of rubber bands commonly used in orthodontia or for connection to a pick tool used to position the upper member during installation upon a patient. For cooperation with the lower member, the upper member is hollow, as at 402a, for at least the length of the threaded end and preferably the entire length of the upper member as shown. The hollow portion is generally round of a diameter slightly larger than that of the smooth end 412 of the lower member 410.

Then the socket 406 is shown generally between the upper member and the lower member. The socket has a round cylindrical shape, generally hollow, and with two open ends. Located towards the upper member, the socket has a threaded opening 407a that receives the threaded end of the upper member. The threading of the opening and the upper member cooperatively engage so the upper member moves axially out from the socket. Generally, the threaded opening extends over half of the length of the socket. Opposite the threaded opening, the socket has a smooth bore 408. The smooth bore has a diameter, as 408a, slightly larger than that of the lower member. The smooth bore and the lower member cooperate so that the lower member slides into and out of the smooth bore with minimal discomfort to the patient. Upon the circumference of the socket and proximate to the end having the smooth bore, the socket has at least three keyholes as at 409a. The keyholes are arranged radially and permit turning of the socket by a cooperating key [not shown]. Turning of the socket extends the upper member outwardly thus lengthening the present invention and advancing the jaw to which it is connected.

Outwards from the smooth bore of the socket, the present invention has the lower member 410. The lower member is generally a solid round cylinder with an end 412 and an opposite head 411. The end of the lower member travels within the hollow portion, as at 402a, of the upper member 402. Inward from the end, the lower member has a shaft 410a. The shaft slides inward and outward from the smooth bore of the socket 406 as the patient moves his or her jaw in speech and in eating. Opposite the end, the lower member has a head 411 generally in line with the shaft, unlike the upper member. The head is rounded for patient comfort and has a central hole that admits a mechanical fastener, such as a screw shown here at 404. The central hole 411a has a recess 411b so the screw fits flush upon the head, also for patient comfort. Near where the head joins the shaft, the shaft has a hole 411c generally perpendicular to the shaft and to the plane of the hole in the head. This hole allows the manufacturer or the orthodontist to fix temporarily the lower member into the socket. Between the end and the head, the lower member has a coaxial spring 413 upon the shaft. The spring provides an expansive force upon the socket which eases the lower jaw forward over time. The spring also assists the patient in extending the lower member from the socket during speech and eating. The spring further protects the patient from abruptly closing the lower member into the socket and damaging this embodiment or the patient's jaw structure.

As the lower member 410 connects forward and downward from the upper member, the present invention must clear the teeth of a patient. FIG. 17 shows an alternate embodiment of the lower member 410 having a partially arcuate shaft. The shaft bends, as at 410b, outwardly from the head and away from the teeth. The shaft remains straight following the bend, as at 410a, generally away from the head. The shaft then carries the spring as before and engages the smooth bore 408 of the socket 406 as before.

Having described the components of the invention, FIG. 18 shows this embodiment installed above and outside the teeth or molars M towards the rear of the upper or maxillary jaw S, part of the skull, and outside the teeth or incisors I of the lower or mandible jaw J of a patient proximate the chin C. This orientation of the invention provides a remedy to overcome an overbite by advancing the mandibular jaw forward. In use, the oral surgeon, in consultation with the orthodontist, determines the attachment points upon the skull and jaw bone on both sides of the patient's head. Following anesthetization of the patient, the oral surgeon then positions the heads of the upper member and the lower member on each side proximate their attachment points, the upper member to the skull above the molars M and the lower member to the jaw bone below the incisors. The oral surgeon then places a mechanical fastener, preferably a screw 404, through the head of the upper member and into the skull S and a second mechanical fastener, preferably a screw, through the head of the lower member and into the jaw bone J proximate the incisors I. The screws are turned so they are flush in the recesses of the heads, thus minimizing abrasion to the adjacent gums and cheeks, and the tongue. The orthodontist then places the socket 406 with its threaded end 407 upon the threaded end 405 of the upper member 402 and then the socket with the smooth bore 408 abuts the spring 413 and receives the smooth end 412 of the lower member 410. The orthodontist then adjusts the socket. The installation is repeated for the other side of the jaw. After the patient recovers from surgery, the orthodontist explains the schedule and method of adjusting the sockets to the patient for moving the lower jaw forward over the time of the treatment.

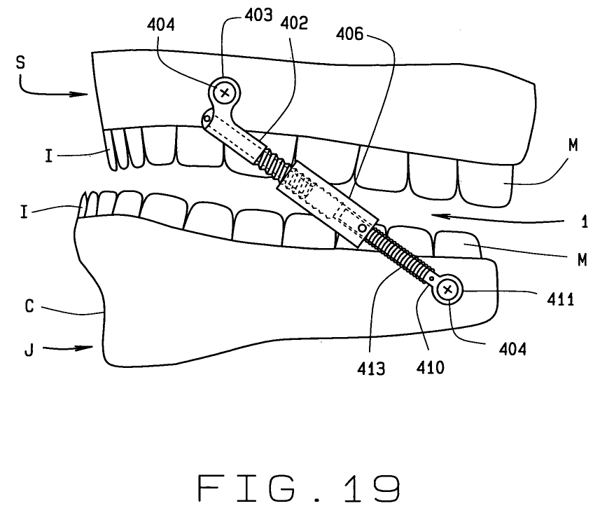

FIG. 19 shows another orientation of the invention, opposite that of FIG. 4 to remedy an underbite by advancing the maxillary jaw forward and to a degree retracting the mandibular jaw. In this orientation, the present invention is installed above and outside the teeth or incisors I towards the front of the upper jaw S, part of the skull towards the nose, and outside the teeth or molars M of the lower or mandible jaw J away from the chin C. As before, the oral surgeon, consulting the orthodontist, determines the attachment points upon the skull and jaw bone on both sides of the patient's head. Following anesthetization of the patient, the oral surgeon then positions the heads of the upper member and the lower member on each side proximate their attachment points, the upper member to the skull above the incisors I and the lower member to the jaw bone below the molars M. The oral surgeon then places a mechanical fastener, preferably a screw 404, through the head of the upper member and into the skull S and a second mechanical fastener, preferably a screw, through the head of the lower member and into the jaw bone J. Once installation is complete, the screws are flush in the recesses of the heads to reduce the abrasion of the adjacent gums and cheeks, and the tongue. The orthodontist then places the socket 406 with its threaded end 407 upon the threaded end 405 of the upper member 402 and then the socket with the smooth bore 408 abuts the spring 413 and receives the smooth end 412 of the lower member 410. The orthodontist then adjusts the socket. The installation is repeated for the other side of the jaw. After the patient recovers from surgery, the orthodontist explains the schedule and method of adjusting the sockets to the patient for moving the upper jaw forward during the treatment plan.

Though mechanical fastening of the invention to the bones of the skull has been described, alternatively the invention installs upon a patient using bands, one band at each head of the invention. A band encircles a tooth to provide a structural and solid platform for connection of the present invention. A band is generally a hollow cylinder of a rigid but shapeable material that conforms to the outer surface of a tooth. The band has a pin extending outwardly therefrom generally upon the surface of the band to be located upon the outside face of a tooth. The pin has a generally solid cylindrical form of sufficient length to fit within the heads of the upper member and the lower member. To prevent detachment of the invention, the pin has an axial threaded hole that receives a screw with a flattened head. The flattened head rests upon the outside of the head of the upper member and the head of the lower member. The flattened edge is generally flush to prevent abrasion of adjacent cheek and gum tissue of the patient.

Bands upon teeth provided for securement of a contracting feature in FIG. 20. A band 276 secures around a molar M toward the rear of the upper jaw S. The band has a threaded aperture that receives a screw 304. The lower jaw J also has a band 276 secure to a tooth ahead of the molars but behind the incisors. The bands secure using present day orthodontic techniques and methods. A spring 500 is provided that has two ends which each engage a clip 501a or an eyelet. The clip has a generally planar form with an aperture for receiving an end of the spring and an opening for admitting the screw 304. This figure shows the screws 304 passing through the openings in the clip for securing the spring between two spaced apart teeth in each jaw. The spring supplies its compressive force upon the lower band which tends to move the lower teeth and the lower jaw rearward. Though one spring is shown in this figure, a second spring is generally supplied upon the opposite side of the jaws for symmetric rearward movement of the lower jaw. As the lower jaw and lower teeth of a patient progress rearward, the orthodontist may adjust the rearward force by replacing the spring with another spring of greater strength. Replacement takes place by removing the screws 304 from the bands 276 and removing a lesser strength spring then installing a higher strength spring proximate the bands. The higher strength spring is then secured using the same screws 304.

Another contracting feature in FIG. 21 attaches to bands 276. As above a band 276 secures around a molar M toward the rear of the upper jaw S where a threaded aperture receives a screw 304. The lower jaw J also has a band 276 secured to a tooth behind the incisors. The bands secure using existing orthodontic techniques and methods including adhesives. The contracting feature includes a Herbst assembly, as at 7, that secures to the screws 304 upon each band in the jaws as previously described in FIGS. 2-10. The assembly 7 has a rod 105 with a ring upon one end. The ring includes an opening that admits a screw 304 into the band upon the lower jaw J. A threaded posterior tube 101 also connects by a screw 304 to the band 276 upon the upper jaw S, generally rearward of the lower jaw band. The posterior tube 101 receives the rod 105 through an axial aperture through the posterior tube. The posterior tube has threading upon its exterior that admits an anterior tube 103. The anterior tube has a hollow cylindrical shape that rotates axially upon the posterior tube. Adjustment of the anterior tube adjusts the spacing between the bands on the upper jaw and the lower jaw so that their relative positions can be adjusted over time.

The preceding devices have secured to the jaws directly, the teeth directly, or to devices contacting the teeth. This embodiment of the present invention secures to an arch wire already mounted upon teeth using existing methods of orthodontics. FIG. 22A shows the components of the present invention, a boss or slide on connector 500. The connector 500 has a base casing 501 and a mating screw 502 similar to screw 304. The base casing includes a base segment 503, generally round, and a body segment 504 also round though of lesser diameter than the body segment and of greater length than the base segment, or the body segment being narrower than the base segment in at least one cross sectional dimension. The base segment and the body segment are integral in a single unit in the preferred embodiment. Alternatively, the base segment is joined to the body segment by welding. In this view, the body segment 504 appears on end and shows an opening 505 that leads into a threaded bore 506 that receives the shaft of the screw 502. The threaded bore has threads that mesh with those of the screw. Opposite the opening 505, the base casing admits two tubes 507, generally coaxial upon a diameter of the base casing. The tubes have a height generally that of the thickness of the base. The tubes extend outwardly from the base segment 503, or perpendicular to the threaded bore 506, and they extend generally in the same plane as the base segment. The tubes are generally hollow and have an internal diameter sufficient to admit existing arch wires.

FIG. 22B shows the base casing 501 from the side. The base segment 503 is generally round and the tubes 507 extend laterally from the base segment. The tubes have a height similar to that of the thickness of the base segment. Upon the base segment, the body segment 504 extends outwardly from the base segment and the tubes. The body segment has a length at least double the thickness of the base segment. While, the tubes 507 have a length at least that of the base segment and body segment combined.

To prepare the present invention for usage, an orthodontist selects an arch wire for the treatment plan as shown in FIG. 23. Then the orthodontist inserts the arch wire, A, through a tube 507 then the base segment 503 and then into the other opposite tube 507. The orthodontist orients the base casing 501 generally upon the outside of the arch wire for installation outwardly upon the teeth towards the cheek of a patient. In the preferred embodiment, the tubes are elongated and generally square in cross section. The square shaped tubes align with square cross section arch wire of various widths. In an alternate embodiment, the tubes are also elongated but with a round cross section for accommodating round arch wire of various diameters.

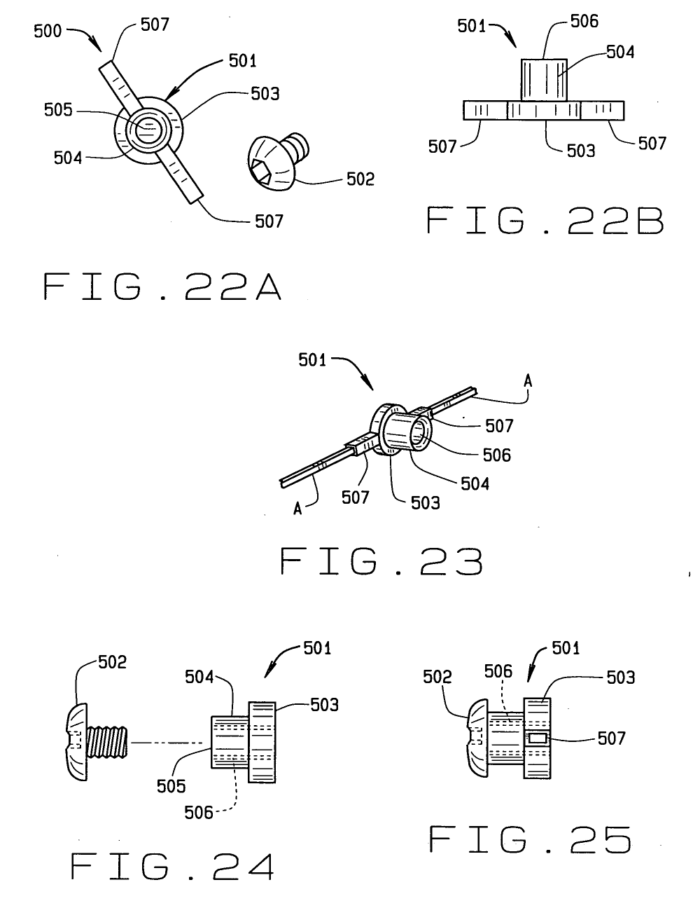

Then FIG. 24 shows an exploded view of the present invention. Unlike prior mounting bosses, the base casing 501 has a threaded bore 506 that extends through the body segment 504 and through the base 503. The threaded bores of the body segment and the base segment are coaxial and in mutual registration. The bore receives the threaded end of the shaft of a screw 502 and allows the screw to turn through the body segment and into the base. Once in the base, the screw engages an arch wire, see FIG. 23, and compresses the arch wire against the base for securement. And, FIG. 25 shows a screw 502 threaded into the bore 506 through the body segment into the base. The tube 507 receives an arch wire that passes through the tube and into the base where the screw abuts the surface of the arch wire. Compressing the arch wire against the base, the screw prevents the base casing from moving along the length of the arch wire and rotating around the cross section of the arch wire.

And following FIGS. 23 and 25, FIG. 26 shows the present invention installed upon a patient. Here, the base casings 501 have been located between pairs of adjacent tooth surface mounted brackets. The base casings have arch wires A threaded through their tubes 507 in their bases 503. Each base casing has a screw 502 that secures a clip 501a, or an eyelet, upon the perimeter of the body segment. Then a spring 500, or other orthodontic mechanism, connects between two spaced apart base casings. Here the base casings are located upon the upper jaw and the lower jaw with those upon the upper jaw more towards the incisors than those upon the lower jaw. Though this arrangement of base casings and springs is shown, the springs may be oriented in an opposite direction as determined by the orthodontist. With the base casings installed upon the arch wires and the screws fixing the base casings in position, the forces generated by the jaws of the patient can be directed into the arch wire. The screw into base casing attachment allows for repositioning of the base casings when an orthodontist changes or adjusts the arch wire during a treatment plan.

Variations or modifications to the subject matter of this development may occur to those skilled in the art upon review of the invention as described herein. Such variations, if within the spirit of this development, are intended to be encompassed within the scope of the invention as explained. The description of the preferred embodiment and as shown in the drawings, are set forth for illustrative purposes only to show the principle and operations of this palatal distraction appliance that attaches directly to the palate of a patient and not the patient's teeth for expansion or contraction of the palate laterally or longitudinally.

1. A connector for attachment to an orthodontic arch wire and supporting pivotal mounting of an orthodontic appliance, said connector comprising:
a base casing having a base segment for attachment to an arch wire, said base segment having an opening formed therein, said opening disposed to receive an arch wire, at least one tube extending perpendicular to said base segment and communicating with said opening, and a body segment being narrower in at least one cross sectional dimension than said base segment;
said body segment having a threaded bore formed therein and said base segment having a threaded bore formed therein perpendicular to said opening and in registration with the bore in said body segment, wherein said threaded bore extends through both said body segment and said base segment; and,
a screw threadedly engaged through said threaded-bore of said body segment and into said threaded bore of said base segment, said screw adapting to receive the orthodontic appliance and to contact the arch wire and to compress the arch wire upon said base segment for securement of said connector against movement and rotation upon an arch wire.

2. The connector of claim 1 wherein said base segment is joined to said body segment by welding.

3. The connector of claim 1 further comprising:
said base casing having said body segment being integral with said base segment.

4. The connector of claim 1 further comprising:
two coaxial tubes locating opposite each other upon said base segment.

5. In an orthodontic appliance for expanding and lengthening the mandibular and maxillary arch of a human patient, the appliance having a plurality of brackets bonded to the exterior surfaces of the teeth of the patient, an arch wire connecting to the brackets upon the mandibular arch or the maxillary arch of the patient, and an assembly to lengthen the mandibular arch or the maxillary arch of the patient, the assembly including a rod nesting with a shaft telescoping from a sleeve, wherein the assembly does not connect directly to any tooth of the patient, the improvement comprising:
at least one connector for attachment to an orthodontic arch wire for the pivotal attachment of the assembly, said connector including a base casing having a base segment and a body segment extending from the base segment, said base segment having a greater width in cross section than said body segment, said base segment having an opening formed therein for the insertion of an arch wire, and at least one tube extending perpendicular to said base segment and communicating with said opening, said body segment having a threaded bore formed therein and said base segment having a threaded bore in registration with the bore in said body segment and perpendicular to said opening and, said threaded bore extending through said base segment; and,
a screw threadedly engaged through said threaded bore of said body segment and into said threaded bore of said base segment, said screw adapting to receive the assembly to lengthen the mandibular arch or the maxillary arch of the patient and to contact the arch wire within said connector and to compress the arch wire upon said base segment for securement of said connector against movement and rotation.

6. The connector of claim 5 further comprising:
two spaced apart tubes generally coaxial and locating opposite each other upon said base segment.

7. An orthodontic appliance for lengthening the mandibular and maxillary arches of a human patient, the appliance comprising:
a plurality of brackets bonded to the exterior surfaces of the teeth of the mandibular arch and the maxillary arch of a patient;
arch wires connecting to the brackets upon the mandibular and maxillary arches of the patient;
at least two connectors, at least one of said connectors locating upon the arch wire upon the mandibular arch and at least one of said connectors locating upon the arch wire upon the maxillary arch;
at least one adjustable connector assembly, said assembly including an expandable tube assembly and a rod which extends through said expandable tube assembly, said expandable tube assembly having a mount at a first end thereof adapted to connect said tube assembly to one of said connectors upon one jaw of the patient, said rod having a mount adjacent a second end of said expandable tube assembly adapted to be connected to another of said connectors upon the other jaw of the patient; and,
each of said connectors including a base casing including a base segment for attachment to an arch wire, said base segment having an opening formed therein receiving an arch wire, at least one tube extending perpendicular to said base segment and communicating with said opening, and a body segment being narrower in at least one cross sectional dimension than said base segment, said body segment and said base segment each having a threaded bore formed therein in mutual registration, and a screw insertable through said mount and threadedly engaged through said threaded bore of said body segment and through said threaded bore of said base segment, said screw adapting to contact an arch wire and to compress the arch wire upon said base segment for securement of said connector against movement and rotation upon an arch wire.

8. The orthodontic appliance of claim 7 wherein the tube assembly includes a hollow posterior tube and an anterior tube which are telescopically connected.

9. The orthodontic appliance of claim 8 wherein said anterior tube includes a hollow body having an externally threaded back end and said posterior tube includes a hollow body defining a bore, said posterior tube being internally threaded at a front end of said tube; said posterior tube bore being sized to accept said anterior tube, said posterior and anterior tubes being threadedly connected together.

10. The orthodontic appliance of claim 9 wherein said posterior tube includes holes adapted to receive a tool to facilitate adjustment of the position of the posterior tube relative to the anterior tube to alter the overall length of the connection assembly.

11. The orthodontic appliance of claim 9 wherein said anterior tube includes indicators to inform a practitioner as to the length of the connection assembly.

12. A boss for the pivotal mounting of an orthodontic appliance outwardly upon the teeth of an arch of a patient comprising:
a base casing including a base segment for attachment to an arch wire, said base segment having an opening formed therein disposed to receive an arch wire, at least one tube extending perpendicular to said base segment and communicating with said opening, and a body segment being narrower than said base segment, said body segment and said base segment each having a coaxial threaded bore formed therein; and,
a screw threadedly engaged through said threaded bore of said body segment and through said threaded bore of said base segment, said screw adapting to contact an arch wire and to compress the arch wire upon said base segment for securement of said connector against movement and rotation upon an arch wire, and said screw disposed to attach to an eyelet of an orthodontic appliance.

13. The boss for the pivotal mounting of orthodontic appliance of claim 12 and including at least one additional tube extending diametrically from the base segment of the said boss, said additional tube having an opening formed therethrough and communicating with the opening of the base segment, whereby the boss, its base segment, and the additional tube can accommodate the locating of an arch wire therethrough before its securement with the said boss and orthodontic appliance and adds further stability to the connection of the base to the arch wire.

14. The boss for the pivotal mounting of an orthodontic appliance as set forth in claim 13, and there being two tubes, each extending diametrically from opposite sides of the base segment, and each having an opening extending therethrough, in alignment with the opening through the base segment, to accommodate the insertion of the arch wire therethrough before the securement of the boss and an orthodontic appliance thereto.

15. In an orthodontic appliance for applying a low- continuous force to the teeth of a human patient, the appliance having a plurality of brackets bonded to the exterior surfaces of the teeth of the patient, an arch wire connecting to the brackets upon the mandibular arch or the maxillary arch of the patient, and an assembly to shift the teeth of the patient, the assembly including a spring assembly that interconnects between brackets connecting with the arch wires operatively associated with the mandibular arch and the maxillary arch of a patient;
at least one connector for attachment to an orthodontic arch wire of the assembly, said connector including a base casing having a base segment and a body segment extending from the base segment, said base segment having a greater width than cross-section and said body segment, said base segment having an opening formed therein for the insertion of an arch therethrough, said body segment having a threaded bore formed therein and said base segment having a threaded bore in registration with the bore in said body segment, said threaded bore extending through said base segment;
a screw threadedly engaging through said threaded bore of said body segment and into said threaded bore of said base segment, said body segment adapted to receive the spring assembly to apply a low-continuous force for shifting of the patient's teeth, and said screw adapted to contact the arch wire within said connector and to compress against arch wire upon said base segment for securement of said connector against movement and rotation, and for securement of the spring assembly to the connector.

16. The orthodontic appliance of claim 15 and wherein said spring assembly interconnects between a connector attaching with the arch wire of the mandibular arch, and the other end of said spring connecting with a connector attaching with the arch wire of the maxillary arch of the patient.

17. The orthodontic appliance of claim 16 wherein said spring having an eyelet provided at each end, and each eyelet provided for mounting onto the perimeter of the body segment of each connector attaching to the maxillary and mandibular arch wires.

18. The orthodontic appliance of claim 17 and including at least one tube extending from the base segment, said tube having an opening provided therethrough and in alignment with the opening through the body segment, for accommodating the insertion of the arch wire therethrough during installation of a connector to an arch wire and adds enhanced stability and resistance to turning of the base upon its arch wire.
